(19) United States
(12) Patent Application Publication
(10) Pub. No.: US 2007/0299749 A1
(43) Pub. Date: Dec. 27, 2007

(54) System and Method for Commodity Consumption Monitoring and Management

(75) Inventor: Robert C. Lovell, Jr., Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: Sybase 365, Inc., Chantilly, VA (US)

(21) Appl. No.: 11/765,769

(22) Filed: Jun. 20, 2007

Related U.S. Application Data
(60) Provisional application No. 60/815,580, filed on Jun. 22, 2006.

(51) Int. Cl. G06Q 10/00; G06Q 20/00; G06Q 30/00; G05B 19/00

(52) U.S. Cl. 705/28; 235/385; 705/22; 340/5.92

(57) ABSTRACT

A service that leverages established wireless messaging paradigms such as, possibly inter alia, Short Message Service, Multimedia Message Service, and IP Multimedia Subsystem to yield an infrastructure that allows a Mobile Subscriber to seamlessly employ their Wireless Device to monitor, and optionally manage, the consumption of one or more commodities. The service may optionally leverage the capabilities of a centrally-located Messaging Inter-Carrier Vendor.

This application claims the benefit of U.S. Provisional Patent Application No. 60/815,580, filed on Jun. 22, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS), Multimedia Message Service (MMS), Internet Protocol (IP) Multimedia Subsystem (IMS), etc.

2. Background of the Invention

As the ‘wireless revolution’ continues to march forward the importance to a Mobile Subscriber (MS), for example a user of a Wireless Device (WD) such as a mobile telephone, BlackBerry, etc. that is serviced by a Wireless Carrier (WC), of their WD grows substantially.

One consequence of the growing importance of WDs is the resulting ubiquitous nature of WDs—i.e., MSs carry them at almost all times and use them for an ever-increasing range of activities.

Concurrent with the advance of the ‘wireless revolution’ many of the resources or commodities that we consume during our daily activities—e.g., sources of energy (such as, inter alia, electricity and natural gas), water, communication bandwidth, etc.—have become scarcer (resulting in, among other things, expanded conservation efforts), dramatically more expensive (resulting in, among other things, greater interest in comprehensive consumption monitoring and control), etc.

The ubiquitous nature of MS′ WDs provide an excellent vehicle through which the consumption of increasingly more expensive, scarce, etc. resources or commodities may be comprehensively monitored and managed. For purposes of illustration consider the following simple examples:

1) Bandwidth. For example, during the downloading of a large media file, during a Voice Over IP (VOIP) session, etc. the consumption of communication bandwidth may increase substantially. Such an increase may pose a challenge for a user (e.g., if the user's service plan provides for a fixed amount of bandwidth) and a user may wish to, possibly among other things, terminate an activity that is contributing to the bandwidth consumption, initiate and/or authorize the acquisition (perhaps for just a specified period of time) of incrementally more bandwidth, etc.

2) Electricity. For example, during a region's summer (air conditioning) season the cost of electricity may rise considerably. Such an increase may pose a challenge for a user (e.g., if the user's service plan provides for a fixed amount of power, or provides for strict time-of-day consumption bounds, etc.) and a user may wish to, possibly among other things, adjust up an air conditioner's thermostat setting; change the timing settings of an appliance, system, device, etc.; shut down an appliance, system, device, etc. that is contributing to the power consumption; initiate and/or authorize the acquisition (perhaps for just a specified period of time) of incrementally more power; etc.

3) Natural Gas. For example, during a region's heating season the cost of natural gas may rise considerably. Such an increase may pose a challenge for a user (e.g., if the user's service plan provides for a fixed amount of gas, or provides for strict time-of-day consumption bounds, etc.) and a user may wish to, possibly among other things, adjust down a heating system's thermostat setting; shut down an appliance, system, device, etc. that is contributing to the gas consumption; initiate and/or authorize the acquisition (perhaps for just a specified period of time) of incrementally more gas; etc.

4) Water. For example, during a region's summer season various water conservation, restriction, etc. regimes may be active. Such regimes may pose a challenge for a user (e.g., if the user's service plan provides for a fixed amount of water, or provides for strict time-of-day consumption bounds, etc.) and a user may wish to, possibly among other things, change the timing settings within a landscape watering system; shut down an appliance, system, device, etc. that is contributing to the water consumption; initiate and/or authorize the acquisition (perhaps for just a specified period of time) of incrementally more water; etc.

The examples that were presented above are illustrative only and it will be readily apparent to one of ordinary skill in the relevant art that numerous other examples are easily possible.

The present invention extends key elements of wireless messaging technology to provide MSs with new and alternative channels through which they can comprehensively monitor and manage their consumption of (possibly expensive, scarce, etc.) resources or commodities.

### SUMMARY OF THE INVENTION

Embodiments of the present invention provide a service that leverages established wireless messaging paradigms such as, possibly inter alia, SMS, MMS, and IMS to yield an infrastructure that allows a MS to seamlessly employ their WD to monitor, and optionally manage, the consumption of one or more commodities.

In an embodiment of the invention a Service Provider (SP) (1) receives, for a MS, details about a commodity from a commodity provider, (2) completes one or more processing steps on the received details (using, possibly inter alia, information that was previously supplied by a Mobile Subscriber), and (3) generates one or more update messages and dispatches the update messages to the MS.

The commodity details may be received by a SP, possibly inter alia, periodically on a scheduled basis or continuously.

The commodity details may include, possibly inter alia, a price component and a consumption component.

An update message may (1) contain, possibly inter alia, a consumption alert, an instantaneous target-versus-plan, a historical target-versus-plan, or a forecast, (2) be delivered via, possibly inter alia, SMS, MMS, or IMS, and (3) optionally contain advertising and/or promotional material.

Another embodiment of the invention includes a SP (1) receiving a reply from a MS (containing one or more directives), (2) processing the directives to yield one or more device adjustments, and (3) adjusting the operation of one or more devices based on the device adjustments.

Still another embodiment provides a method of commodity consumption monitoring and management that includes causing a wireless message to be sent to a mobile subscriber, the wireless message including information about consumption of a commodity. A reply from the mobile subscriber is thereafter received, and the reply includes a directive to control further consumption of the commodity. In response to the reply, a control message is sent to a device that consumes the commodity to control the device such that the device modifies its consumption of the commodity.

In one possible implementation, a commodity price update triggers the sending of the initial wireless message.

The commodity that is being monitored and controlled may be, among others, electricity and bandwidth.

In accordance with a feature of the present invention the mobile subscriber may send a query message regarding the consumption of the commodity, and the message triggers the initial wireless message to be sent.

In yet another embodiment of the present invention, there is provided a method of controlling consumption of a commodity including registering a mobile subscriber to receive alerts regarding consumption of a commodity, receiving information about the consumption of the commodity, causing a wireless message to be sent to the mobile subscriber when the consumption of the commodity exceeds a predetermined threshold set during the step of registering, receiving a reply to the wireless message including a directive to control a device that consumes the commodity, and sending a control message to the device such that the device modifies its consumption of the commodity.

These and other features of the embodiments of the present invention along with their attendant advantages will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates various of the exchanges or interactions that are supported by aspects of the present invention.

FIG. 3 presents an illustrative consumption curve chart that may be generated in accordance with aspects of the present invention.

FIG. 4 presents another illustrative consumption curve chart that may be generated in accordance with aspects of the present invention.

FIG. 5 is a diagrammatic presentation of aspects of an exemplary Service Provider (SP) Application Server (AS).

### DETAILED DESCRIPTION OF THE INVENTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same.

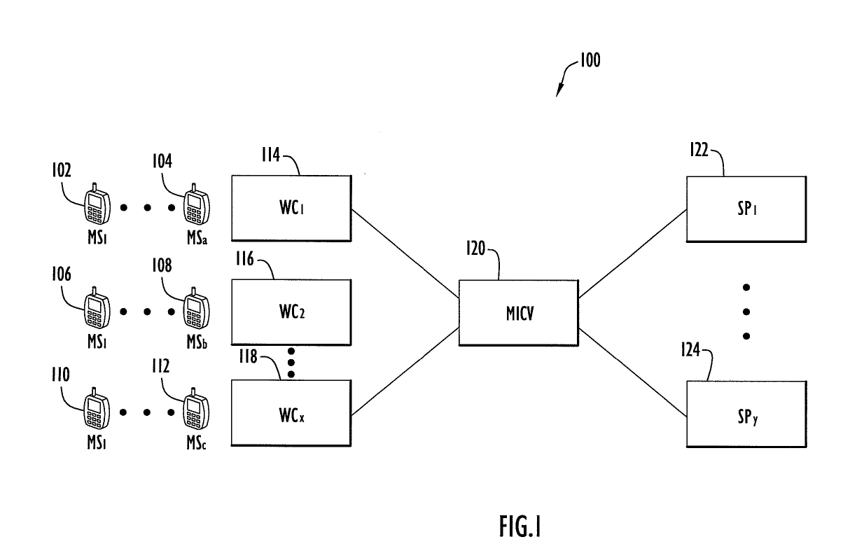

As illustrated by FIG. 1 and reference numeral 100 a MICV 120 is disposed between, possibly inter alia, multiple WCs (WC₁ 114→WCₓ 118) on one side and multiple SPs (SP₁ 122→SP_{y} 124) on the other side and thus ‘bridges’ all of the connected entities. A MICV 120 thus, as one simple example, may offer various routing, formatting, delivery, value-add, etc. capabilities that provide, possibly inter alia:

1) A WC, WC₁ 114→WCₓ 118 (and by extension all of the MSs [MS₁ 102→MSₐ 104, MS₁ 106→MS_{b} 108, MS₁ 110→MS_{c} 112] that are serviced by a WC [WC₁ 114→WCₓ 118]), with ubiquitous access to a broad universe of SPs (SP₁ 122→SP_{y} 124), and

2) A SP (SP₁ 122→SP_{y} 124) with ubiquitous access to a broad universe of WCs (WC₁ 114→WCₓ 118 and, by extension, to all of the MSs [MS₁ 102→MSₐ 104, MS₁ 106→MS_{b} 108, MS₁ 110→MS_{c} 112] that are serviced by a WC [WC₁ 114→WCₓ 118]).

Generally speaking a MICV may have varying degrees of visibility (e.g., access, etc.) to the (MS← →MS, MS← →SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV it will be readily apparent to one of ordinary skill in the relevant art that numerous other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SPₓ offers a service that has been enhanced or augmented as provided through aspects of the instant invention and Mary, a MS, uses SPₓ's service.

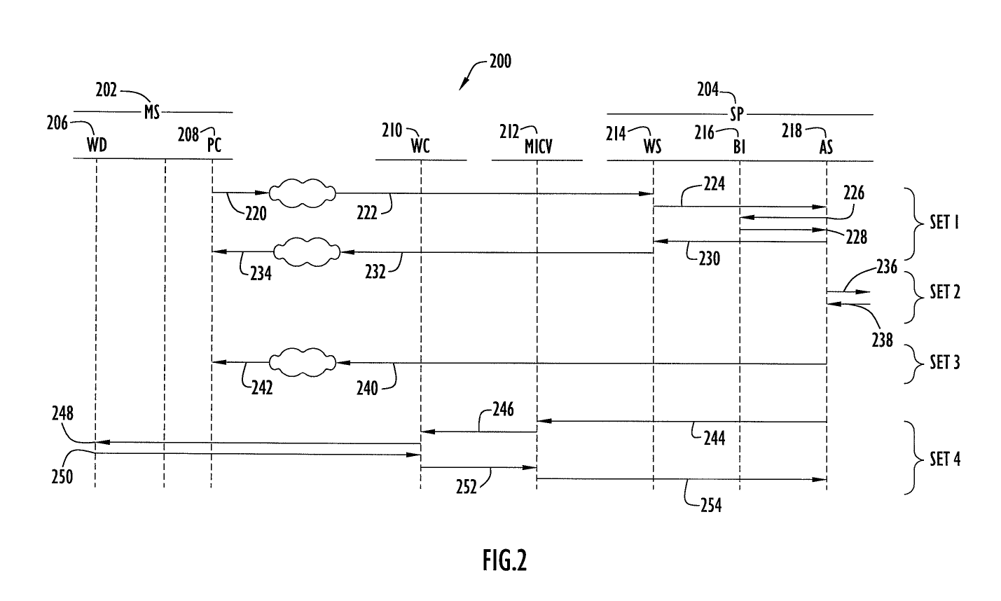

FIG. 2 and reference numeral 200 illustrate various of the exchanges or interactions that might occur under a portion of our hypothetical example. Of interest and note in the diagram are the following entities:

MS 202 WD 206. For example, Mary's WD such as a mobile telephone, BlackBerry, PalmPilot, etc.

MS 202 Personal Computer (PC) 208. For example, one of Mary's 202 home, work, etc. PCs.

WC 210. The provider of service for Mary's 202 WD 206.

MICV 212. As noted above the use of a MICV, although not required, provides significant advantages.

SP 204 Web Server (WS) 214. A publicly-available World Wide Web (WWW) site that is optionally provided by SPₓ 204.

SP 204 Billing Interface (BI) 216. A single, consolidated interface that SPₓ 204 may use to easily reach, inter alia, one or more external entities such as a credit card or debit card clearinghouse, a carrier billing system, a service bureau that provides access to multiple carrier billing systems, etc.

SP 204 AS 218. Facilities that provide key elements of the instant invention (which will be described below).

It is important to note or observe that in FIG. 2:

1) The MS 202 WD 206 and MS 202 PC 208 entities are illustrated as being adjacent or otherwise near each other. In actual practice the entities may, for example, be physically located anywhere.

2) The messages are shown traversing a MICV 212.

3) The SP 204 may employ a Short Code (SC) or a regular Telephone Number (TN) as its source address (and to which it would ask users of its service to direct any messages). While the abbreviated length of a SC (e.g., five digits for a SC administered by Neustar under the Common Short Code [CSC] program) incrementally enhances the experience of a MS 202 (e.g., the MS 202 need remember and enter only a few digits as the destination address of a message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY,” which is incorporated herein by reference.

In FIG. 2 the exchanges that are collected under the designation Set 1 represent the activities that might take place as Mary (as our MS 202) completes a registration process with SPₓ 204. For example:

A) Mary 202 uses one of her PCs 208 to visit SPₓ's 204 WS 214 to, possibly among other things, complete a service registration process (220→222).

B) SPₓ's 204 WS 214 interacts with SPₓ's 204 AS 218 to, possibly among other things, commit some or all of the information that Mary provided to a data repository (e.g., a database), optionally complete a billing transaction, etc (224).

C) As appropriate and as required a BI 216 completes a billing transaction (226→228).

D) SPₓ's 204 WS 214 responds appropriately (e.g., with the presentation of a confirmation message, etc.) (232→234).

The specific exchanges that were described above (as residing under the designation Set 1) are illustrative only and it will be readily apparent to one of ordinary skill in the relevant art that numerous other exchanges are easily possible and indeed are fully within the scope of the present invention. As just one example, the registration process may be completed through any combination of one or more channels including, inter alia, the indicated WWW facility, wireless messaging (SMS, MMS, IMS, etc.), Electronic Mail (E-Mail) messages, Instant Messaging (IM) exchanges, conventional mail, telephone, Interactive Voice Response (IVR) facilities, etc.

During the registration process that was described above a range of information may be captured from a MS including, inter alia:

1) Identifying Information (e.g., general information about Mary). For example, possibly among other things, a unique identifier and a password, optionally a pseudonym or handle, name, address, age, etc.

2) Billing Information. Different service billing models may be offered by SPₓ including, possibly inter alia, free (e.g., possibly advertising-based), a fixed one-time charge, a recurring (monthly, etc.) fixed charge, a recurring (monthly, etc.) variable charge, a per-use charge, etc. Different payment mechanisms may be supported by SPₓ including, possibly among other things, credit or debit card information, authorization to place a charge on a MS's phone bill, etc.

3) Commodities (e.g., information about each of the commodities that Mary consumes and wishes to monitor and manage). For example, commodity type; commodity provider; account particulars (number or identifier, usage plan [including, possibly inter alia, day-of-week constraints, time-of-day constraints, etc.], payment schedule, etc.); limits or thresholds on any combination of price, consumption, etc.; the desired target or goal consumption model; etc.

4) Devices (e.g., information about each of the devices, systems, appliances, etc. that Mary owns or employs and which consume some resource or commodity—residential and/or commercial items such as, inter alia, clothes washer, clothes dryer, range, oven, dishwasher, air conditioner, furnace, Heating Ventilation Air Conditioning [HVAC] complex, lighting systems, watering facilities, television, computer, etc.). For example, device name, location, type, commodity/commodities consumed, optionally any access particulars (including, possibly inter alia, the IP or other address through which the device may be reached, user identifier and password, etc. for message-connected or otherwise enhanced or augmented devices), limits or thresholds on commodity consumption, desired target or goal commodity consumption model, etc.

The specific pieces of information that were described above are illustrative only and it will be readily apparent to one of ordinary skill in the relevant art that numerous other pieces of information are easily possible and indeed are fully within the scope of the present invention.

As noted above the information that Mary provided during the registration process may be preserved in a data repository (e.g., a database) and may optionally be organized as a MS Profile.

The content of Mary's profile may optionally be augmented by SPₓ. For example, one or more internal or external sources of consumer, demographic, psychographic, etc. information may be leveraged to selectively enhance or augment elements of Mary's profile.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

In FIG. 2 the exchanges that are collected under the designation Set 2 represent the activities that might take place as SPX 204 registers, coordinates, etc. with a commodity provider to, possibly among other things, receive from commodity provider periodic commodity price, commodity consumption, etc. updates (236→238).

The specific exchanges that were described above (as residing under the designation Set 2) are illustrative only and it will be readily apparent to one of ordinary skill in the relevant art that numerous other exchanges (including, inter alia, a commodity provider optionally explicitly confirming with a MS 202 their desire/acceptance before beginning to provide commodity consumption information to a SP 204; updates to various of the information in a MS Profile in a SP's 204 repository; a SP 204 dispatching one or more test messages to each of the message-connected or otherwise enhanced or augmented devices that were identified during the registration process; etc.) are easily possible and indeed are fully within the scope of the present invention.

In FIG. 2 the exchanges that are collected under the designation Set 3 represent the activities that might take place as SPX 204 dispatches to Mary 202 one or more confirmation E-mail messages (240→242).

The specific exchanges that were described above (as residing under the designation Set 3) are illustrative only and it will be readily apparent to one of ordinary skill in the relevant art that numerous other exchanges (including, inter alia, other types or forms of confirmation messages) are easily possible and indeed are fully within the scope of the present invention.

In FIG. 2 the exchanges that are collected under the designation Set 4 represent the activities that might take place as SPₓ's 204 AS 218 dispatches one or more confirmation SMS, MMS, IMS, etc. messages to Mary's 202 WD 206 (244→248) and Mary 202 (perhaps optionally) replies or responds to the message(s) (250→254). In the instant example the messages are shown traversing a MICV 212. The SP 204 may employ a SC or a regular TN as its source address (and to which it would ask users of its service to direct any reply messages).

The specific exchanges that were described above (as residing under the designation Set 4) are illustrative only and it will be readily apparent to one of ordinary skill in the relevant art that numerous other exchanges are easily possible and indeed are fully within the scope of the present invention.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention.

The information that was described above may be subsequently managed (e.g., existing information may be edited or removed, new information may be added, etc.) through any combination of one or more channels including, inter alia, a SP's WWW facility, wireless messaging (SMS, MMS, IMS, etc.), E-mail messages, IM exchanges, conventional mail, telephone, IVR facilities, etc.

To continue with our hypothetical example . . . After completing the registration process SPₓ may begin to receive price, consumption, etc. information from various of the commodity providers that were specified by Mary. Additionally, Mary may begin to receive updates from SPₓ—e.g., based on a schedule that was previously defined by Mary, when one or more triggers or thresholds (e.g., the volume of consumption of a commodity, the price of commodity, etc.) that were previously defined by Mary are realized, on-demand (i.e., in response to an explicit request from Mary), etc.

The updates that Mary receives may travel through any combination of one or more channels including, inter alia, a SP's WWW facility, wireless messaging (SMS, MMS, IMS, etc.), E-mail messages, IM exchanges, conventional mail, telephone, IVR facilities, etc. and include any number of elements including, inter alia, simple text, graphic images, video, audio, etc. and combinations of same. Consider the following illustrative examples (which employ an SMS/MMS/IMS/etc. message channel):

1) The instantaneous time-of-day target/plan vs. actual consumption curve chart that is depicted in FIG. 3 (and reference numeral 300) might be dispatched to Mary when the consumption of a specific commodity exceeds a pre-defined threshold level.

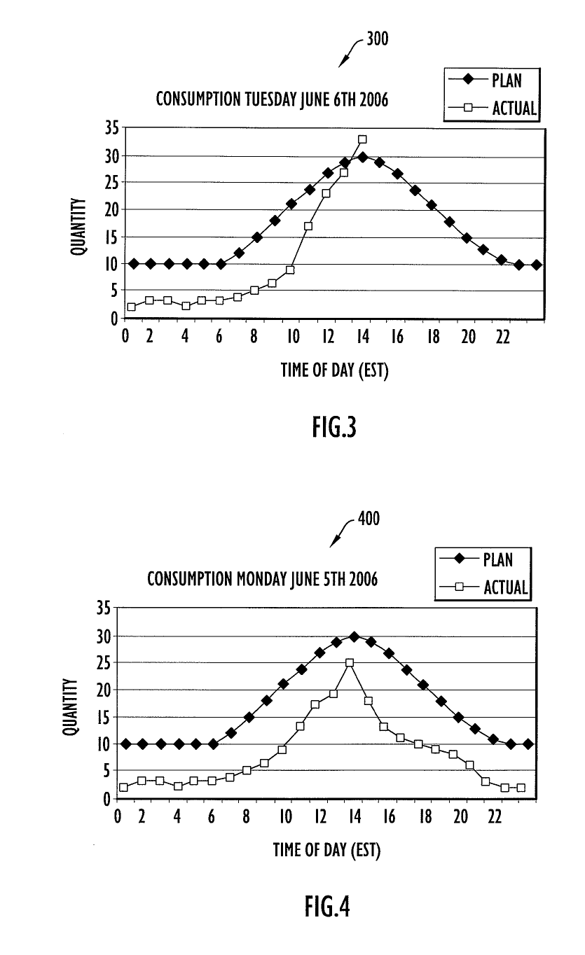

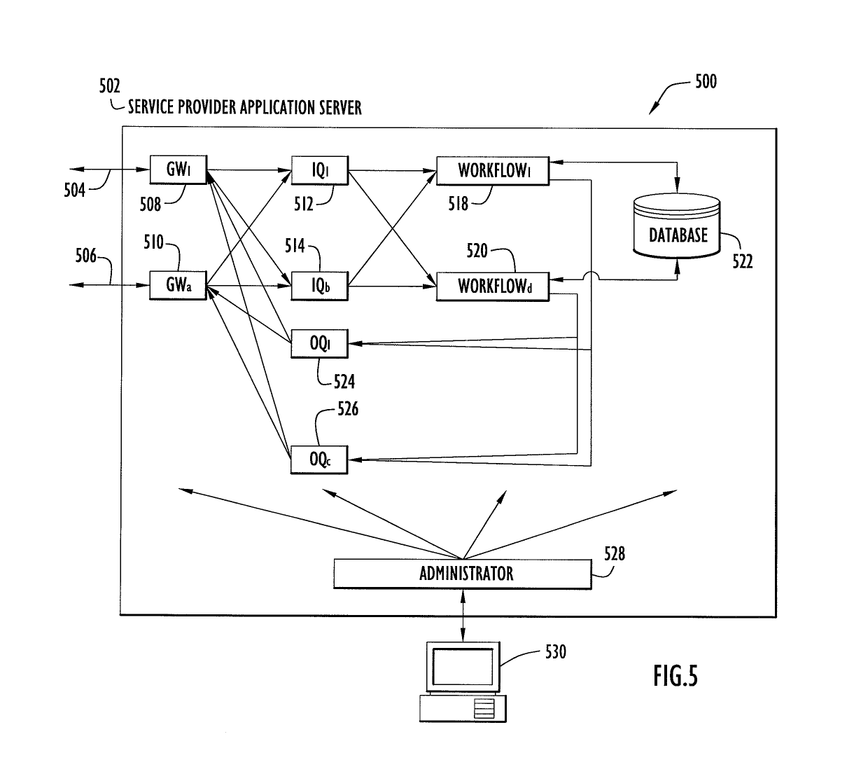

2) The historical time-of-day target/plan vs. actual consumption curve chart that is depicted in FIG. 4 (and reference numeral 400) might be dispatched to Mary in response to an on-demand request from Mary (for a specific day—Monday 5 Jun. 2006 in the instant example). Similar charts, covering possibly inter alia a previous week or month or quarter or year or etc. period, might be returned to Mary in response to an on-demand request from Mary (that specifies, possibly inter alia, commodity type, appropriate date/time value or range, desired summary type, etc.).

3) A SP may optionally provide a forecast or projection capability through which a future consumption curve (for, as an example, a specified commodity at or over a specified period of time) may be constructed and delivered to Mary. Under such an offering a SP may optionally allow Mary to iteratively contribute new or different model parameters, receive an updated future consumption curve, contribute new or different model parameters, receive an updated future consumption curve, etc.—in effect, allowing Mary to perform various ‘what if?’ planning, etc. exercises.

A SP may include any number of informational elements in the consumption curve charts that it generates and dispatches including, inter alia, descriptive text (e.g., the name and type of a commodity, the name of a commodity provider, etc.), advertising, promotional material, etc.

A SP may optionally receive price updates from a commodity provider thus positioning a SP to, possibly inter alia, optionally update or alert a MS to commodity price fluctuations (e.g., +/−a defined amount), possibly vis-à-vis one or more MS-defined triggers or thresholds, in support of price-based use or consumption.

A SP may optionally allow a MS to adjust their consumption of a commodity through any combination of one or more channels including, inter alia, a WWW facility, wireless messaging (SMS, MMS, IMS, etc.), E-mail messages, IM exchanges, conventional mail, telephone, IVR facilities, etc. Such adjustments may, possibly inter alia, be manual (e.g., increase or decrease consumption by some specific amount for some specific period of time), be automatic (e.g., request a SP to dynamically modify the rate of consumption so that the adjusted rate returns a consumption curve to a pre-defined plan or goal), be a combination of manual and automatic, etc.

In support of the above a SP may optionally interact with, manage or otherwise control the operation, timing settings, etc. of one or more (e.g., message-connected or otherwise enhanced or augmented) devices. Illustrative examples may include, inter alia, turning an appliance, lighting system, etc. off or on; resetting the start/end timings of an appliance, system, etc.; starting/initiating and/or ending/terminating a controlling process; adjusting up or down a heating and/or cooling system's thermostat; etc. A SP may reach or interact with devices either directly (e.g., through a public IP address via the Internet, etc.) or indirectly through one or more intermediaries (e.g., that serve as a gateway, that provide a facade for private or proprietary device addressing schemes, etc.). The SP may interact with devices (that consume a commodity) upon receipt of a directive from the MS, or without such a directive if authorized (expressly or impliedly) to do so.

Incremental changes (e.g., increases, decreases) in the consumption of a commodity (as indicated by Mary, as dictated by SP, etc.) may result in one or more new billing transactions (e.g., to authorize or pay for an increase, to receive credit for a decrease, etc.) through a SP's BI.

The catalog of processing steps that were described above are illustrative only and it will be readily apparent to one of ordinary skill in the relevant art that numerous other processing steps are easily possible and indeed are fully within the scope of the present invention.

A SP may optionally provide any number of value-add additions to the core functionality that was described above. Such additions may carry an incremental (one-time, recurring, etc.) fee or charge. For example:

1) For bandwidth consumption a SP may offer a ‘preview’ capability that would provide a visual, etc. depiction of what an image, video element, etc. would look or appear like with some incremental increase or decrease in bandwidth.

The confirmation, response, etc. message(s) that were described above may include any number of textual, visual, etc. information elements.

The confirmation, update, etc. message(s) that were described above may optionally contain an informational element—e.g., a relevant or applicable factoid about a specific commodity, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location-Based Service [LBS] facility).

The confirmation, update, etc. message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The confirmation, update, etc. message(s) may optionally contain promotional materials (e.g., still images, video clips, etc.).

FIG. 5 and reference numeral 500 provide a diagrammatic presentation of aspects of an exemplary SP AS 502. The illustrated AS 502 contains several key components—Gateways (GW₁ 508→GWₐ 510 in the diagram), Incoming Queues (IQ₁ 512→IQ_{b} 514 in the diagram), WorkFlows (WorkFlow₁ 518→WorkFlow_{d} 520 in the diagram), Database 522, Outgoing Queues (OQ₁ 524→OQ_{c} 526 in the diagram), and an Administrator 528. It will be readily apparent to one of ordinary skill in the relevant art that numerous other components are possible within an AS 502.

A dynamically updateable set of one or more Gateways (GW₁ 508→GWₐ 510 in the diagram) handle incoming (e.g., SMS/MMS/IMS/etc. messaging, etc.) traffic and outgoing (e.g., SMS/MMS/IMS/etc. messaging, etc.) traffic. Incoming traffic is accepted and deposited on an intermediate or temporary Incoming Queue (IQ₁ 512→IQ_{b} 514 in the diagram) for subsequent processing. Processed artifacts are removed from an intermediate or temporary Outgoing Queue (OQ₁ 524→OQ_{c} 526 in the diagram) and then dispatched.

A dynamically updateable set of one or more Incoming Queues (IQ₁ 512→IQ_{b} 514 in the diagram) and a dynamically updateable set of one or more Outgoing Queues (OQ₁ 524→OQ_{c} 526 in the diagram) operate as intermediate or temporary buffers for incoming and outgoing traffic.

A dynamically updateable set of one or more WorkFlows (WorkFlow₁ 518→WorkFlow_{d} 520 in the diagram) remove incoming traffic from an intermediate or temporary Incoming Queue (IQ₁ 512→IQ_{b} 514 in the diagram), perform all of the required processing operations (more about this below), and deposit processed artifacts on an intermediate or temporary Outgoing Queue (OQ₁ 524→OQ_{c} 526 in the diagram).

The Database 522 that is depicted in FIG. 5 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

As depicted in FIG. 5 an Administrator 528 provides management or administrative control over all of the different components of an AS 502 through, as one example, a WWW-based interface 530. It will be readily apparent to one of ordinary skill in the relevant art that numerous other interfaces (e.g., a data feed, an Application Programming Interface [API], etc.) are easily possible.

Through flexible, extensible, and dynamically updatable configuration information a WorkFlow component may be quickly and easily realized to support any number of activities. For example, WorkFlows might be configured to support a registration process; to support interactions with a commodity provider; to support the receipt and processing of price, consumption, etc. updates from commodity providers; to support the generation and dispatch of confirmation, update, etc. messages; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support:

1) Scheduled (e.g., daily, weekly, etc.) and/or on-demand reporting with report results delivered through SMS, MMS, IMS, etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, IMS, etc. messages; through E-Mail; through a WWW-based facility; etc.

It is important to note that while aspects of the discussion that was presented above focused on the use of SCs, it will be readily apparent to one of ordinary skill in the relevant art that TNs and other message address identifiers are equally applicable and, indeed, are fully within the scope of the present invention.

The discussion that was just presented referenced two specific wireless messaging paradigms—SMS and MMS. These paradigms potentially offer an incremental advantage over other paradigms in that native support for SMS and/or MMS is commonly found on a WD that a potential MS would be carrying. However, it is to be understood that it would be readily apparent to one of ordinary skill in the relevant art that other paradigms (IMS, etc.) are fully within the scope of the present invention.

The foregoing disclosure of the preferred embodiments of the present invention, which was described in the narrative and which was illustrated in the accompanying figures, has been presented for purposes of illustration and description. It is not intended to be exhaustive or to limit the invention to the precise forms disclosed. It will be readily apparent to one of ordinary skill in the relevant art that numerous alternatives to the presented embodiments are easily possible and, indeed, are fully within the scope of the present invention.

The following list defines acronyms as used in this disclosure.

| Acronym | Meaning |
|---|---|
| API | Application Programming Interface |
| AS | Application Server |
| BI | Billing Interface |
| CSC | Common Short Code |
| DBMS | Database Management System |
| E-Mail | Electronic Mail |
| GIS | Geographic Information System |
| GW | Gateway |
| HVAC | Heating Ventilation Air Conditioning |
| IM | Instant Messaging |
| IMS | IP Multimedia Subsystem |
| IP | Internet Protocol |
| IQ | Incoming Queue |
| IVR | Interactive Voice Response |
| LBS | Location-Based Service |
| MICV | Messaging Inter-Carrier Vendor |
| MMS | Multimedia Message Service |
| MS | Mobile Subscriber |
| ODBMS | Object Database Management System |
| OQ | Outgoing Queue |
| PC | Personal Computer |
| RDBMS | Relational Database Management System |
| SC | Short Code |
| SMS | Short Message Service |
| SP | Service Provider |
| TN | Telephone Number |
| VOIP | Voice Over IP |
| WC | Wireless Carrier |
| WD | Wireless Device |
| WF | WorkFlow |
| WS | Web Server |
| WWW | World Wide Web |

What is claimed is:

1. A method for commodity consumption monitoring and management, comprising:
in connection with a Mobile Subscriber receiving from a commodity provider details about a commodity;
performing one or more processing steps on said details using at least in part information previously supplied by said Mobile Subscriber; and
generating one or more update messages and dispatching same to said Mobile Subscriber;

2. The method of claim 1, wherein said details are received continuously.

3. The method of claim 1, wherein said details are received periodically on a scheduled basis.

4. The method of claim 1, wherein said details contains at least a price component and a consumption component.

5. The method of claim 1, wherein said information is defined by a Mobile Subscriber during a registration process.

6. The method of claim 5, wherein said information defined during said registration process includes one or more of Identifying Information, Billing Information, Commodity Information, and Device Information.

7. The method of claim 5, wherein information defined during said registration process is preserved through a User Profile.

8. The method of claim 5, wherein said registration process is Web-based.

9. The method of claim 5, wherein said registration process includes a billing component.

10. The method of claim 1, wherein said update messages include a consumption alert.

11. The method of claim 1, wherein said update messages include an instantaneous target-versus-plan.

12. The method of claim 11, wherein the instantaneous target-versus-plan is presented as a chart.

13. The method of claim 1, wherein said update messages include a historical target-versus-plan.

14. The method of claim 13, wherein the historical target-versus-plan is presented as a chart.

15. The method of claim 1, wherein said update messages include a forecast.

16. The method of claim 15, wherein the forecast is presented as a chart.

17. The method of claim 15, further comprising:
receiving a response from said Mobile Subscriber containing new forecast parameters;
performing one or more processing steps on said response to yield a new forecast; and
generating one or more update messages containing said new forecast and dispatching same to said Mobile Subscriber.

18. The method of claim 17, wherein said response is delivered through at least one of a Short Message Service message, Multimedia Message Service message, or IP Multimedia Subsystem message.

19. The method of claim 1, further comprising:
receiving a reply from said Mobile Subscriber containing one or more directives;
performing one or more processing steps on said directives to yield one or more device adjustments; and
adjusting the operation of one or more devices based on said device adjustments.

20. The method of claim 19, wherein said reply is delivered through at least one of a Short Message Service message, Multimedia Message Service message, or IP Multimedia Subsystem message.

21. The method of claim 19, wherein said device adjustment is completed manually.

22. The method of claim 19, wherein said device adjustment is completed automatically.

23. The method of claim 1, wherein said update messages are delivered through at least one of a Short Message Service message, Multimedia Message Service message, or a IP Multimedia Subsystem message.

24. The method of claim 23, wherein said update messages contain advertising and/or promotional material.

25. A method of commodity consumption monitoring and management, comprising:
causing a wireless message to be sent to a mobile subscriber, the wireless message including information about consumption of a commodity;
receiving a reply to said message from the mobile subscriber, the reply including a directive to control further consumption of the commodity; and
sending a control message to a device that consumes the commodity to control the device such that the device modifies its consumption of the commodity.

26. The method of claim 25, further comprising receiving a price update from a commodity provider, which price update triggers the step of causing the wireless message to be sent.

27. The method of claim 25, wherein the commodity is electricity.

28. The method of claim 25, wherein the commodity is bandwidth.

29. The method of claim 25, further comprising receiving an inquiry from a mobile subscriber regarding the consumption of the commodity, which query triggers the step of causing the wireless message to be sent.

30. A method of controlling consumption of a commodity, comprising:
registering a mobile subscriber to receive alerts regarding consumption of a commodity;
receiving information about the consumption of the commodity;
causing a wireless message to be sent to the mobile subscriber when the consumption of the commodity exceeds a predetermined threshold set during the step of registering;
receiving a reply to said wireless message including a directive to control a device that consumes the commodity; and
sending a control message to the device such that the device modifies its consumption of the commodity.
